(19) United States
(12) Patent Application Publication
(10) Pub. No.: US 2009/0282437 A1
(43) Pub. Date: Nov. 12, 2009

(54) System and Method for Controlling Media at a Plurality of Output Devices

(75) Inventors: John MALEC, Chicago, IL (US); Sam T. MELTON, Aurora, IL (US); Justin M. BINNS, Joliet, IL (US); Sven T. DAVIES, Chicago, IL (US)

Correspondence Address: FITCH EVEN TABIN & FLANNERY, 120 SOUTH LASALLE STREET, SUITE 1600, CHICAGO, IL, 60603-3406, US

(73) Assignee: TAP.TV, Burr Ridge, IL (US)

(21) Appl. No.: 12/344,743

(22) Filed: Dec. 29, 2008

Related U.S. Application Data
(60) Provisional application No. 61/052,083, filed on May 9, 2008.

(51) Int. Cl. H04N 5/445; H04N 7/173

(52) U.S. Cl. 725/40; 725/105

(57) ABSTRACT

A media managing system and method for controlling and distributing media output at a plurality of output devices includes at least one interface configured to provide to a user a visual graphical menu of a plurality of options to associate signals from media source(s) with the plurality of media output devices and effect signals to the media output devices. A computing device communicates with the interface(s) and the output devices and/or the media source to associate signals from the media source(s) with the plurality of output devices. The visual graphical menu provides a visual graphical display of the media source(s) and at least some of the output devices available for association to permit the user to select and associate the at least one media source with one or more of the plurality of media devices and distribute audio and/or video signals to user selected output devices.

### RELATED APPLICATION(S)

This application claims the benefit of U.S. Provisional application No. 61/052,083, filed May 9, 2008, which is incorporated by reference in its entirety herein.

### TECHNICAL FIELD

This invention relates generally to controlling provision of media at a plurality of output devices.

### BACKGROUND

Many public places have been incorporating an increasing number of television or other video devices throughout their spaces to provide multiple sources of entertainment or information. For example, in a bar setting, multiple televisions are placed throughout the establishment such that patrons may watch a variety of programming, such as various sporting events, at the same time. Similarly, restaurants will include televisions to provide television content or other background visual effects, depending on the time and situation for its patrons. For instance, a restaurant may want to provide the ability to watch certain programming on a weekend while providing a visual background such as the image of a fire to enhance the ambiance of the space during late evening hours.

With the proliferation of televisions and other video or multimedia devices throughout such public places and private settings, venue operators may struggle with managing the output on all of the devices and managing the increasing number of possible media sources such as cable provided media, satellite media, online media, and the like. Typically, each television will be connected to a single media source, such as cable or a satellite receiver, and each television or media control box will have separate controllers such as hand-held remote controls to control the channel or output. If a remote controller is lost or confused for a remote controller for another television or media source box, it becomes difficult to change a channel at the request of a patron or according to a manager's wishes.

It is also possible that an establishment may have many more televisions than media sources. In such a case, multiple televisions are typically connected to a single media source. Although each television may be separately controlled, it is possible that all of those televisions must show the same programming from the media source thereby reducing the entertainment options for the establishment's patrons. The proliferation of high definition media also makes for a degraded quality of the television display when multiple televisions are pulling media signals from a single source. To address this problem, multiple set top boxes may be introduced to the system, further complicating control of the displays. Alternatively, a source converter box may be used in conjunction with a switch, but control of the switch and connecting the televisions to the media signals is not readily provided for in prior systems, thereby requiring expert configuration of the cabling and the switch when changes in the programming displayed on the venue's televisions is desired. Traditional multimedia systems also typically do not provide for controlling and displaying online or dedicated media content.

These environments also limit the ability to track and determine the number of people watching certain media or programming. It is becoming increasingly common for people to watch sporting events and other televised events or shows at public establishments or larger scale private gatherings instead of in their homes. The ability to track how many people are watching such events is therefore decreased. Also, in the case where an establishment has agreed to display a certain amount of a given programming type, such statistics are difficult to track, especially in a system with multiple, independently controlled televisions and media sources.

### SUMMARY

Generally speaking, and in various embodiments, a system and method for controlling and distributing media output at a plurality of output devices is described. In the system and method at least one interface is configured to provide to a user a visual graphical menu of a plurality of options to associate signals from at least one media source with the plurality of media output devices and effect signals to the media output devices such as a plurality of video output devices. A computing device is configured to communicate with the at least one interface and at least one of the media output devices and/or at least one of the media sources to send commands to the media source(s) and/or the media output device(s) to effect a configuration of the source and/or media output device. The computing device receives signals from the interface and associates signals from the at least one media source with the plurality of output devices. The visual graphical menu provides to the user a visual graphical display of the at least one media source and at least some of the plurality of output devices available for association. The visual graphical menu permits the user to select and associate programming from the at least one media source with one or more of the plurality of media devices and distribute one or more of the signals selected from the group consisting of video signals and audio signals to user selected output devices. The system also can include a storage device able to store historical information regarding what information or media programming was shown from the output devices, when the programming was shown, and on which output devices the programming was displayed.

In one approach, the system operates to visually display an array of the plurality of output devices on a menu illustrated on an interface screen and to visually display the media source(s) on the menu illustrated on the interface screen. The system can accept a user input relating to the media source and the plurality of output devices and communicate the user input to a computer device that associates the user input related to the media source and the plurality of output devices to effect a signal from the media source to the output device.

In another aspect, the system for controlling media output from a plurality of media sources to a plurality of video output devices includes at least one interface screen configured to visually illustrate to a user a plurality of media sources and a plurality of video output devices. A computer is configured to communicate with the interface screen, to effect signals to the plurality of the video output devices for example through a switching device, and to communicate with at least one of the group consisting of at least one of the plurality of media sources and at least one of the plurality of video output devices to send commands to at least one of the plurality of media sources and the plurality of video output devices to effect a configuration of the media source(s) and/or the video output device(s) to associate signals effected by the user's selection of media sources with signals effected to the video output devices based upon the user's selection of video output devices on the interface screen.

In yet another aspect, a method of distributing signals from at least one media source to a plurality of video output devices includes visually displaying an array of the plurality of output devices on a menu illustrated on an interface screen and visually displaying the at least one of the media source on the menu illustrated on the interface screen. The method also includes accepting a user input relating to the at least one of the of media source and the plurality of output devices and communicating the user input to a computer device that associates the user input related to the media source and the at least one of the plurality of output devices to effect a signal from the media source to the output device. A command signal may be communicated from the computer device to at least one of the group consisting of the at least one media source and at least one of the plurality of video output devices to effect a configuration of one of the media source(s) and/or video output devices to effect the signal from the media source to the output device

So configured, the system may provide a variety of menus for associating media content or programming with certain output devices, such as televisions. A user may then use the menus at one or more conveniently placed interfaces to control all of the televisions in the establishment, thereby reducing or eliminating the need to use separate controls to control the televisions or media sources. The system also can track display data, for example, to maintain programming display data for the establishment or to confirm that certain media is being displayed for a given amount of time. These and other benefits may become clearer upon making a thorough review and study of the following detailed description.

### BRIEF DESCRIPTION OF THE DRAWINGS

The above needs are at least partially met through provision of the system and method for controlling media at a plurality of output devices described in the following detailed description, particularly when studied in conjunction with the drawings, wherein:

FIG. 1 comprises a block diagram of an example controller system as configured in accordance with various embodiments of the invention;

FIG. 2 comprises an example interface display of an example controller system as configured in accordance with various embodiments of the invention;

FIG. 3 comprises an example interface display as configured in accordance with various embodiments of the invention;

FIG. 4 comprises an example interface display as configured in accordance with various embodiments of the invention;

FIG. 5 comprises an example interface display as configured in accordance with various embodiments of the invention;

FIG. 6 comprises an example interface display as configured in accordance with various embodiments of the invention;

FIG. 7 comprises an example interface display as configured in accordance with various embodiments of the invention

FIG. 8 comprises a block diagram of an example controller system as configured in accordance with various embodiments of the invention;

FIG. 9 comprises a flow diagram of a method of controlling a system as configured in accordance with various embodiments of the invention;

FIG. 10 comprises a block diagram of an example controller system for a plurality of locations as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

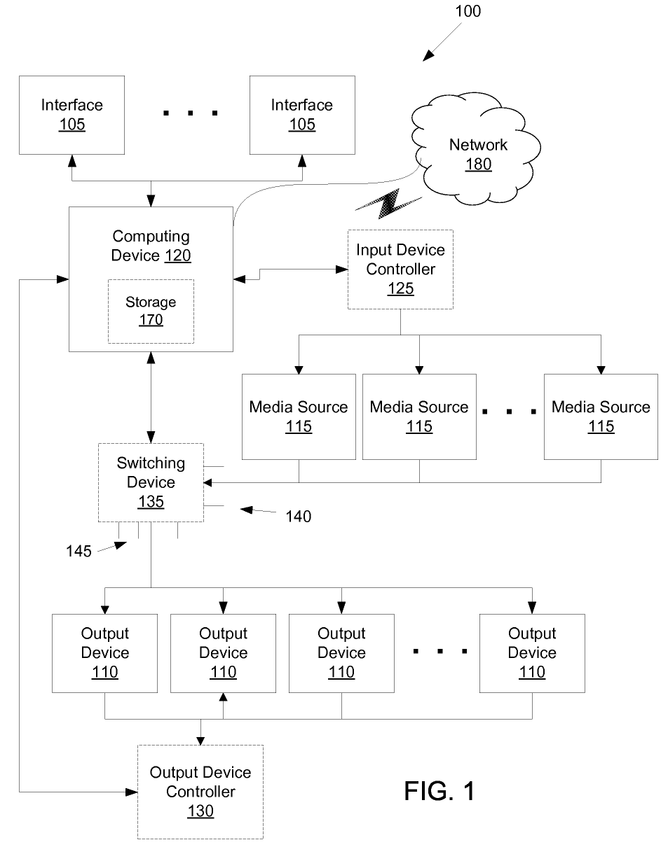

Referring now to the drawings, and in particular to FIG. 1, an illustrative system 100 includes at least one interface 105 configured to provide to a user a visual graphical menu of a plurality of options to associate signals from at least one media source 115 with a plurality of media output devices 110 and effect signals to the media output devices 110. The media sources 115 comprise any source of multimedia content that may be played at an output device 110. The media sources 115 may include a primary media source and/or a secondary media source. Example primary media sources include a cable provider source, a satellite media provider source, online content, an audio media source, specially provided media content (for example, a content box configured to provide specialty programming from a dedicated source, such as TAP.TV content), pre-recorded media content (for example, media provided on a digital video disk (“DVD”), on video tape, or on a digital video recorder), or other media provider. Any or all of these sources are typically provided through a media content providing device such as a cable or satellite box. Example secondary media sources include programming, networks, stations, and other content as may be available from a single primary media source. Another example of a secondary media source is an overlay or pass-through device wherein the pass-through device accepts programming from another media source 115 and adds a banner of additional video or other programming next to or over a portion of the accepted programming such that programming from the pass-through source includes the programming or content from the first source 115 and the banner information from the pass-through source. A given system 100 can have any number of each of these various sources in any combination.

The output device 110 may be any device able to play or display media content. Non-limiting examples include televisions, video display devices, projection systems, and the like. A computing device 120 is configured to communicate with the interface(s) 105 and at least one of the group consisting of at least one media source 115 and at least one of the media output devices 110. The computing device 120 is configured to receive signals from the interface(s) 105 and associate signals from the at least one media source with the plurality of output devices 110. The visual graphical menu provided by the interface(s) 105 provides to the user a visual graphical display of the at least one media source and the plurality of output devices available for association, thereby permitting the user to select and associate a media source with one or more of the plurality of media devices and distribute video signals and audio signals to user selected output devices 110.

The interface 105 may be provided in a number of forms. For example, the interface 105 may comprise a touch screen or touch screen monitor such that a user can merely tap to select elements or tap and drag elements on the touch screen to allow the user to interact with the system 100. By another approach, the interface 105 may include a computing device interface such as a video monitor for a personal computer with a screen and a pointing device, such as a mouse, to allow the user to provide inputs to and read information from the system 100. By still another approach, the interface 105 may comprise portable communication devices such as phones, personal digital assistants, and the like. Other methods of interacting with a computerized system are known or may be created in the future and may be incorporated into or comprise the interface 105 and need no further discussion herein.

The visual graphical menu 200 provided by the interface 105 and computing device 120 can provide any number of display options to the user. For example, the visual graphical menu may include one or more of the following graphical displays: a floor plan comprising a representation of at least some of the output devices 110, a listing of available media sources 115 and a floor plan 210 comprising a representation of at least some of the output devices 110 such that the computing device 120 associates user selected output devices 110 on the floor plan 210 with media sources 115 visually illustrated on the graphical menu, a floor plan 210 comprising a graphic representation of at least one of the output devices 110 that is at least similar to a graphic representation of a media source 115 to visually associate the at least one of the output devices 110 with a media source 115, a listing 310 of output devices 110, a listing 410 of groups 420 of output devices 110, a program listing, a network listing, a station listing 510, a listing 235 of available media sources, a listing of available media sources at a plurality of times, a listing 520 of available programming at a plurality of times, a plurality of images relating to available programming on a guide 505, a plurality of images relating to available programming on a guide 505 at a plurality of times, a plurality 710 of thumbnails 715 comprising images representing media sources. Other versions of the visual graphical menu may be displayed by the interface 105.

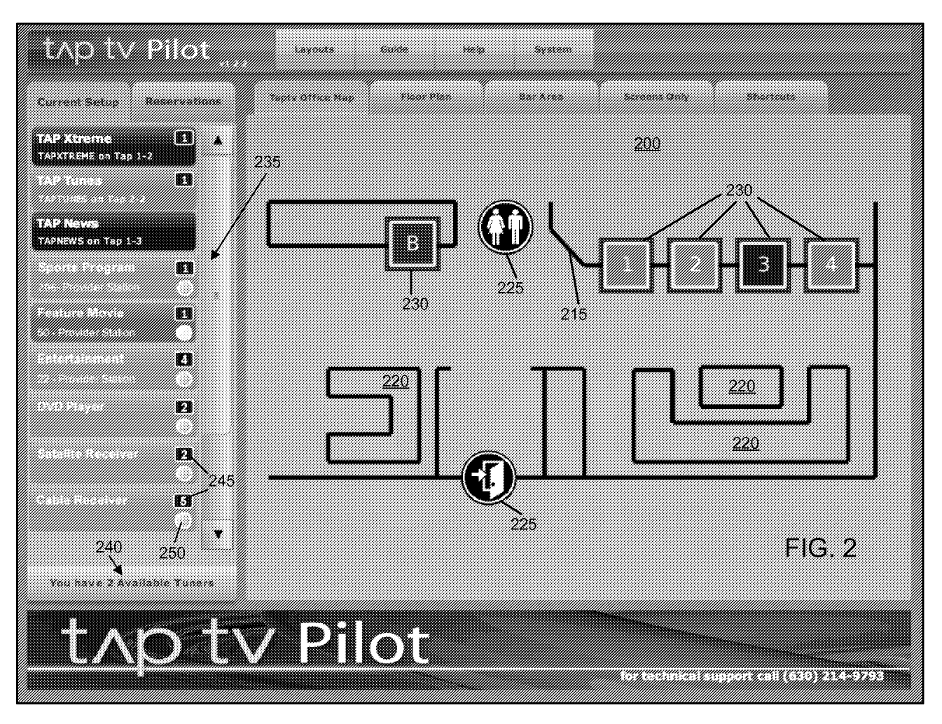

The floor plan approach to the visual graphical menu 200 will be described with reference to FIG. 2. The interface 105 interacts with the computing device 120 such that the interface 105 can provide to the user a graphical representation 205 of a floor plan 210 of the establishment. For instance, the graphical representation 205 may show walls 215 and furniture 220 disposed in the space represented by the floor plan 210. Icons 225 may be used to show the placements of exits or restrooms. Graphical representations 230 of the output devices 110 show the placement of the output devices 110 in the space. By one approach, the representations 230 of the output devices 110 may be color coded or have graphical indications to indicate to the user which channels or media sources are associated with or being provided or shown on those output devices 110. The color coding or graphics may extend also to a media source listing 235 to show which colors or graphics correspond to which media source 115. An indicator 240 may inform the user of the number of available tuners on the system 100. The media source listing 235 may include graphical indications 245 indicating how many output devices 110 are associated with each media source 115. The media source listing 235 may also include graphical indications 250 indicating whether the computing device 120 is able to communicate with the indicated media source 115.

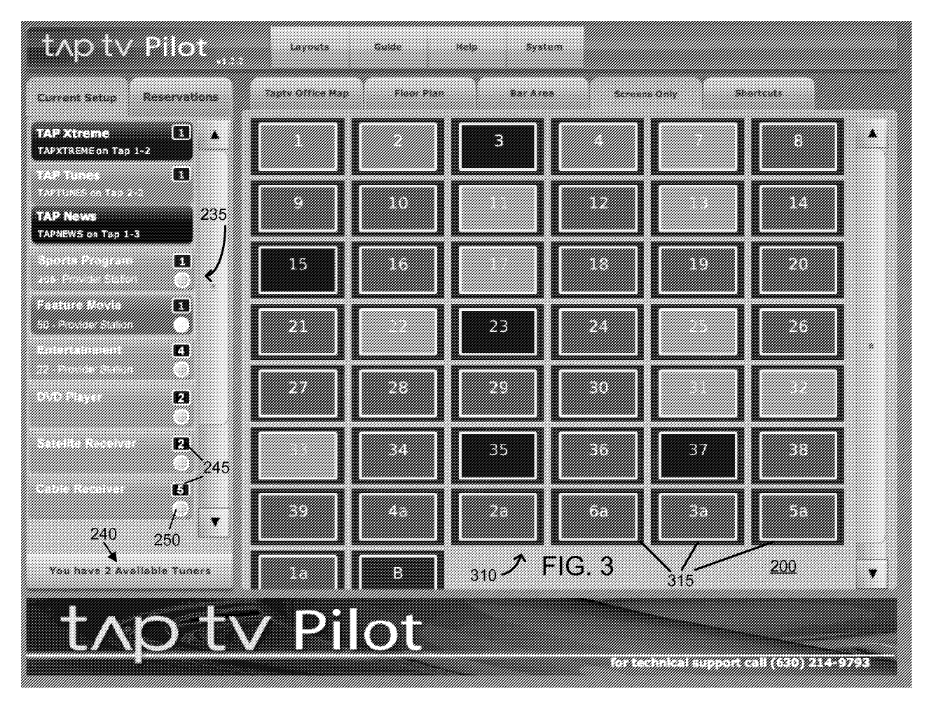

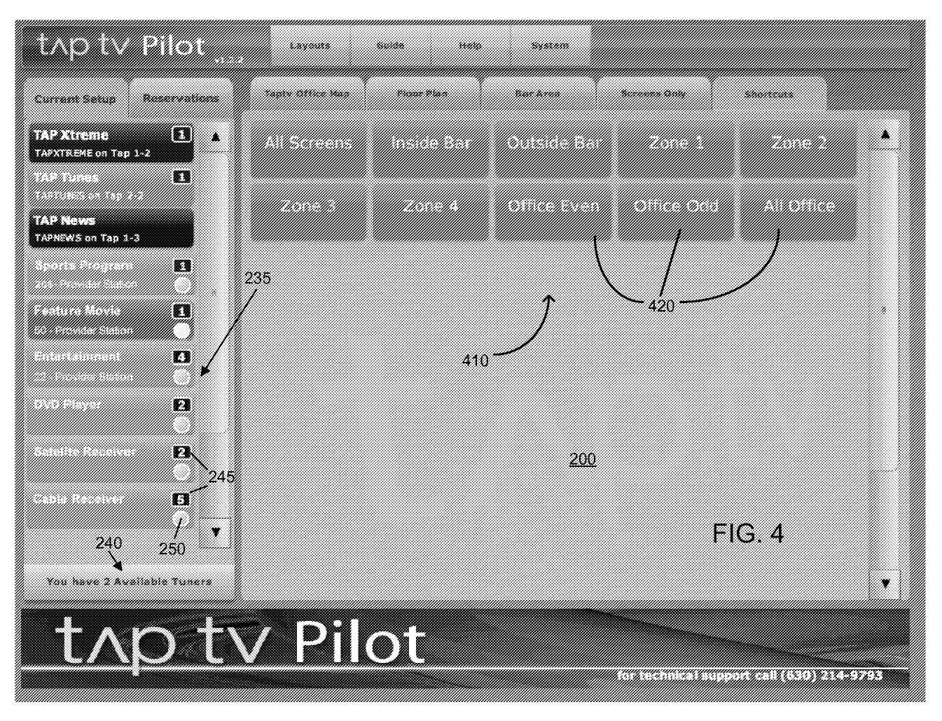

By another approach, the visual graphical menu may include a listing 310 of output devices 110, shown for example in FIG. 3. The output devices 110 can be identified by number or other identifier. The listing 310 may include representations 315 of the output devices 110 that may be color coded or have graphical indicators to assist in identifying media source 115 associations as described above. By a different approach shown in FIG. 4, the output devices 110 may be grouped together such that a listing 410 of the groups is provided to the user. Each representation 420 of a group of output devices 110 can then act similarly to a representation 315 of a signal output device 110. For instance, an association of the representation 420 of the group of output devices 110 provides the same association for all of the output devices 110 of the group. The output devices 110 may be grouped in any manner, for example, by room, by wall, by zone, by number grouping, or the like. The visual graphical menu in these approaches may also include an indication or listing 235 of which media sources are associated with the output devices 110.

In any of the above approaches, the computing device 120 may be configured to sort the media source listing 235. A single media source indication in the media source listing 235 may also be selected, for example through a double tap on a touch screen, to view further details regarding the media source 115. In one example, details regarding the media being provided by the specific media source 115 are shown to the user in response to selection including program name, program description, and control buttons to trigger various functions as may be used for the selected media source 115. One of the functions may include a guide button that when selected triggers a listing of programs, networks, or stations currently available through that cable source, and the user may then select a different program, network, or station to be provided by the cable television media source.

By yet another approach, the program, station, and/or network listings may be provided without the indicators of the output devices 110. Examples of programming include the shows available from a media source 115. Example networks include ABC, NBC, and other providers of shows or programming, or for online or dedicated sources, the various media streams or content as may be available at a given time. Example stations include local channels such as “channel 2” or “channel 7.” In either approach, the various listings typically show the available programming, stations, or networks for the output devices 110. The various listings may have graphic representations as described above, including color coding, a text description of the media source or program, graphics, lines, icons, or other indication of an association with output devices 110.

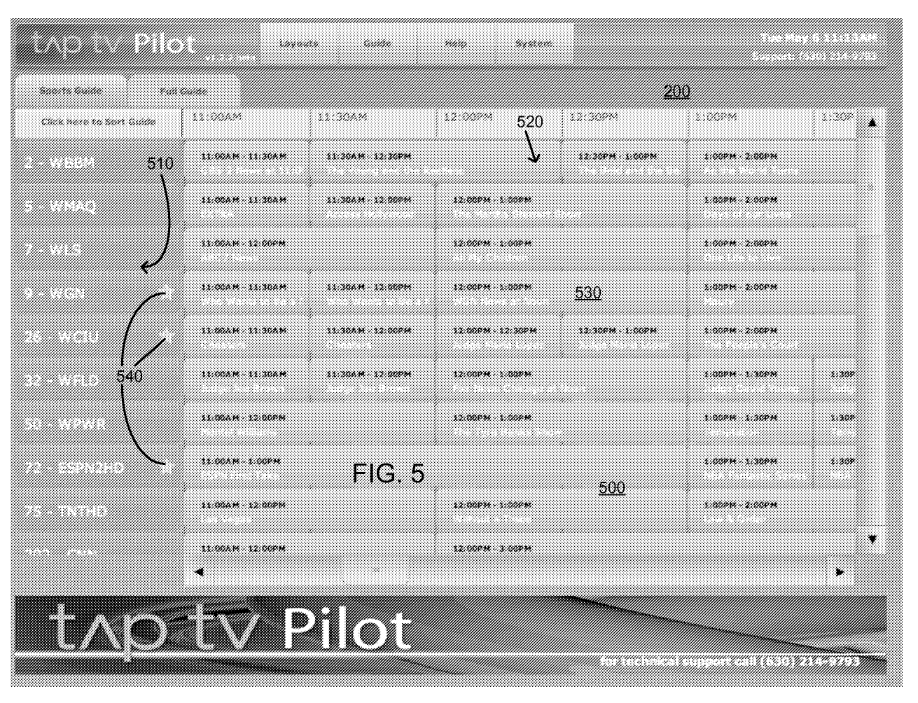

By still another approach, a guide may be provided to show information at a plurality of times other than only for the current arrangement. One example guide 500 is shown in FIG. 5. In the example, the available stations are displayed in a station listing 510 along with a listing of the programming 520 on each station as may be available at a plurality of times. One option includes configuring the computing device 120 to allow a user to designate preferred stations, networks, and/or programming. A graphical indicator 540 for preferred elements can be provided in the visual graphical menu 200.

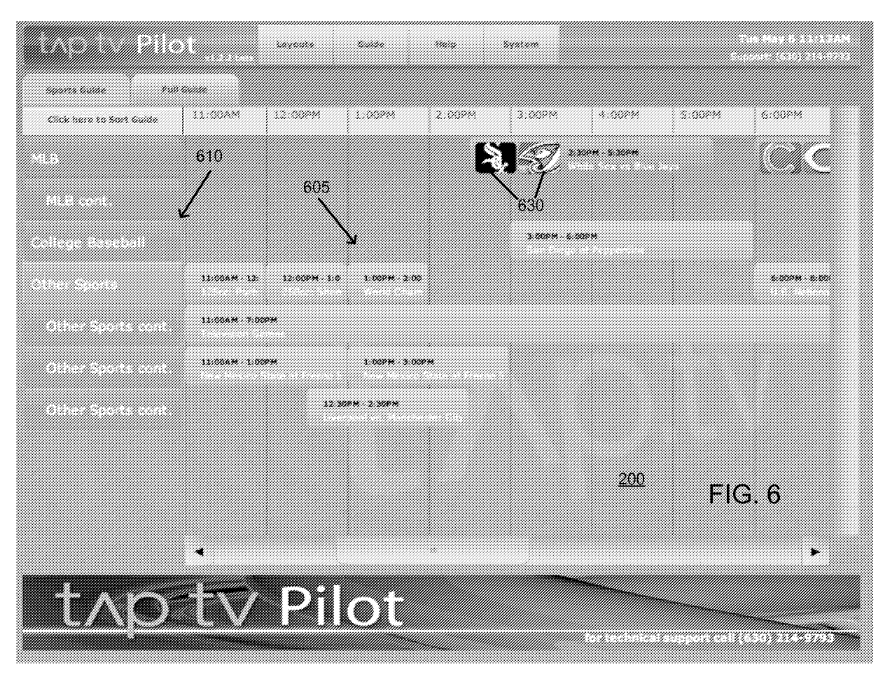

The various listings discussed herein may be sorted in various ways. For example, the preferred stations, networks, and/or programming may be sorted to the top of the list. By another approach, the listing 235 may be sorted by programming topic. For example, as shown in FIG. 6, the available programming 605 over time is filtered by sports topics 610 to show only sports programming. FIG. 6 also shows an example of images 630 relating to available programming on a visual graphical menu 200, wherein the images convey information regarding the available programming.

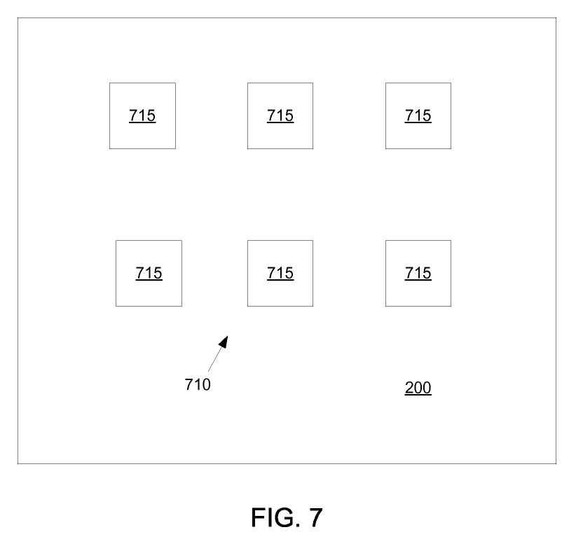

By a further approach to the guide, an example of which is shown in FIG. 7, the media sources or channels may be provided to the user in a plurality of thumbnails 710 such that the user can see what content is being provided on each source, network, or channel to facilitate the user's selection of content to associate with the output devices. For example, the thumbnail 715 displays the media playing on the channel represented by the thumbnail 715. By another approach, the thumbnails 715 may comprise screenshots of the media provided on the media source represented by the thumbnail 715. The user may then select the thumbnail 715 as part of associating the media sources with the output devices 110.

So configured, the graphical menu may be used in a variety of ways by the user to control when and what is displayed in a venue using this system. For example, a user may set the system 100 to automatically associate certain media sources or programming with the output devices 110 at a particular time in the future. Should the user request certain programming at a certain time, the system may determine which media source can provide the program if the program is available from multiple media sources 115, such as cable and satellite, or the system can determine which network to display if the program is available from multiple networks from a single media source, such as from a standard definition network and a high definition network.

With reference again to FIG. 1, the computing device 120 behind the controller system 100 may be provided in a number of ways. By one approach, the computing device 120 may comprise a personal computer or similar computing device with input and output connections as known in the art for connecting to the various other system 100 components as described herein. In a different approach, the computing device 120 can communicate with the other system 100 components via a local network connection as known in the art. For example, the computing device 120 may communicate with a media source 115 to control the programming provided by the media source 115, and/or the computing device may communicate with an output device 120 to control the channel or input controls for the output device 120. For instance, if a cable source without a control box is provided to a television, the computing device 120 can control the television channel to effect display of particular programming. By another example, the television may be provided with multiple media sources, and the computing device 120 may control a cable box to provide certain programming to the television for display. The computing device 120 runs software on a processor to perform the visual graphical menu provision and association operations as may be provided and used by a user, among other features as are described herein. Information for the system specific to a single location such as the number and arrangement of the output devices 110, the available media sources, and the floor plan 210 is entered into the system 100 upon installation. This set up information may be modified as needed. Information regarding the programming information may be entered manually or downloaded from a network 180 such as the Internet.

By one approach, the software for controlling the associations between the media sources 115 and the output device 110 includes a routing table that is configured during the set up and the installation of the system. For instance, a venue can be mapped in advance including a description of the media sources 115 and the output devices 110 available at the venue. The routing table prepared in software reflects this map. For example, the routing table can include information including whether certain output devices 110 can accept certain types of video such as component or high definition video or whether certain media sources can provide multiple outputs. The routing table may include information regarding the configuration of the switching device 135. A second software module includes a logic system that uses the routing table to provide the visual graphic menu to the user via the interface 105 appropriate for the venue and to process inputs from the user to affect association of a signal from a media source 110 with particular output devices 110. Such software running on the computing device 120 and its processor is readily developed by those skilled in the art to perform such functions. Those skilled in the art will recognize and appreciate that such a processor can comprise a fixed-purpose hard-wired platform or can comprise a partially or wholly programmable platform. All of these architectural options are well known and understood in the art and require no further description here.

Additional, optional features as may be included with the system 100 include where the computing device 120 is configured to disable at least one of the media sources 115 such that the disabled media sources are not available to the user to be associated with an output device 110. In this manner, certain sources may be made unavailable for association or display on the output devices 110. In another example, the box for a media source 115 may be malfunctioning such that the bad signal from the device is blocked and not able to be associated with the output devices 110. In a similar manner, certain programming or networks may be blocked so as to not be available. For example, certain networks may carry programming or content that a certain venue may not wish to be displayed, and the venue manager may therefore block such channels or programming to restrict access to the content.

In one approach to blocking, the locked media sources, networks, programming, or stations are not provided to the user as an option for use when associating content with the output devices 110. By another approach, the media source 115, programming, networks, or stations may be displayed to the user with an indication that the source is unavailable. Should a user attempt to associate or display blocked content, the user may be provided with an indication, such as a noise and/or a visual cue, that the blocked content is unavailable or unchangeable. Although the blocking is described as being applied through the computing device 120 such that the computing device will not allow display of the blocked content through control of the media sources 115, the computing device 120 when configured to communicate with the output devices 100 can apply the blocking at the output device 110 where the output device 110 contains a blocking feature.

Another option includes where the computing device 120 is configured to lock at least one of the media sources 115 to a particular network or station such that a locked indication is provided to a user via the at least one interface 105 when the user attempts to change a locked media source 115. By this approach, a particular media source 115, such as a particular cable or satellite box, may act as a dedicated source for a particular network. For example, a sports bar may desire to have a dedicated source 115 for a particular sports-dedicated network. In another example, a facility catering to financial professionals may wish to lock certain output devices 110 to a network providing only market data or other financial information. Should a user attempt to change the channel for that media source 115, the user may be provided with a noise and/or visual cue that the media source 115 is locked. The locked indication may include a prompt for the user to check with management regarding the user-requested change, or the locked indication may ask for a security code to change the locked status of the media source.

Yet another option includes where the computing device 120 is configured to lock at least one of the media sources 115 to at least one output device 110 such that a locked indication is provided to a user via the at least one interface 105 when the user attempts to change a locked output device 110. By this approach, a particular media source 115 may be locked to a particular output device 110. For example, certain output devices 110 may be locked into displaying data from a DVD player. Should a user attempt to change the media source 115 association for that output device 110, the user may be provided with a noise and/or visual cue that the output device 110 is locked. By one approach, the locked indication may include a prompt for the user to check with management regarding the user-requested change, or the locked indication may ask for a security code to change the locked status of the output device 110. Depending on the venue's preferences, the computing device 120 may be configured to allow a user to override a locked indication. So configured with any one or more of the above optional configurations for the computing device 120, the system 100 provides the establishment's management with increased control over the media provided in the establishment.

With reference again to FIG. 1, the system 100 may optionally include an input device controller 125 in communication with the computing device 120 to facilitate communication between the computing device 120 and the media sources 115. The input device controller 125 is configurable to be in communication with at least one of the media sources 115 to control provision of content provided by the media sources 115. The input device controller 125 allows for control of each media source 115. Non-limiting examples of such control include changing a channel on a cable box, triggering a digital video recording device to play certain content, or prompting a DVD player to play a given DVD. Given the various forms that a media source 115 may comprise, the input device controller 125 may comprise any of the known ways to communicate with such devices. For example, the input device controller 125 may include an infra-red controller, a network connection between the system 100 and the media source 115, and a wireless network connection between the system 100 and the media source 115. The input device controller 125 may then be configurable to detect and control at least one operating state of the media source 115. The operating state of a media source 115 may include, for example, the on/off state of the device, the network or station provided by the device, the playback operation of the device (for example the play, pause, and stop functions on a DVD player), and the like. So configured, the states of the sources 115 may be collected and analyzed by the computing device 120 to provide additional functionality and control to a user.

The system 100 may also optionally include an output device controller 130 in communication with the computing device 120 to facilitate communication between the computing device 120 and the media sources output devices 110. The output device controller 130 is configurable to be in communication with at least one of the plurality of output devices 110 to detect and control at least one operating state of the output device(s) 110. The output device controller 130 allows for control of the output device 110, for example, to change a channel on the output device 110, to change an input setting for the output device 110, to change the on/off state of the output device 110, control display settings for the output device 110, and the like. The output device controller 130 is in communication with the output devices 110 by any known means including, for example, serial communication, infra-red communication, and the like. So configured, the states of the output devices 110 may be collected and analyzed by the computing device 120 to provide additional functionality and control to a user. The input device controller 125 and the output device controller 130 may comprises physically distinct elements as shown in FIG. 1, or the elements may be combined into a signal physical element in communication with the output devices 110 and the media sources 115.

The system 100 may optionally include a switching device 135. The switching device 135 typically includes a plurality of inputs 140 configured to receive media signals from media sources and a plurality of outputs 145 configured to provide media signals. The switching device 135 is controlled by the computing device 120 to associate certain of the plurality of inputs 140 with certain of the plurality of outputs 145. So configured, the switching device 135 more readily allows the system 100 to switch the media sources 115 to be associated with different output devices 110. For example, without a switching device 135, the system 100 typically will have each output device 110 connected to a particular media source 115 or as many sources 115 as the output device 110 has inputs, and the system 100 can control the displayed channels or programming that are available through the media sources 115 connected to the output device 110. The output device 110, however, in such a configuration cannot readily be connected to additional media sources 115.

The switching device 135 in one approach comprises a dynamically controlled switch that allows the output device 110 to receive media content from any media sources 115 connected to the switching device 135. In one such approach, the switching device 135 includes inputs 140 able to receive video information in each of composite video form, S-video form, and component video form. The method can be expanded to high definition content such as is carried in the so called high-definition multimedia interface (“HDMI”) format. Such switching devices 135 are commercially available and controllable by software run on either the computing device 120 and/or the switching device 135 such that the computing device 120 in combination with the switching device 135 can route the video signals to output devices 110 connected to the switching device 135 outputs 145.

By another approach, the switching device 135 may comprise a scalable switch system for connecting a plurality of output devices 110 to at least one media source including an array of input connectors configured to receive media signals and a first array of first jumper connections electrically connected to the array of input connectors such that at least one input connector of the array of input connectors electrically connects to a first jumper connection and the input connector connected to the first jumper connection is electrically connected to a termination resistance when the first jumper connection for the input connector is in a first jumper configuration. This configuration of the switching device 135 also includes an array of output connectors configured to provide media signals and a second array of second jumper connections configured to electrically connect one of at least two input connectors to an output connector of the array of output connectors. Such a switching device 135 may also include a switching circuit in communication with the first array of jumper connections, the second array of jumper connections, and the array of output connectors. A controller circuit is in communication with the switching circuit to control a switching configuration of the switching circuit to associate signals received at the input connectors with certain of the output connectors.

This approach to the switching device may be configured where the array of input connectors comprises a first sub-array of input connectors configured such that each of the first sub-array of input connectors connects to one output connector of the array of output connectors regardless of a jumper configuration of the first array of jumper connections. The array of input connectors may include a second sub-array of input connectors wherein the second array of jumper connections for the switching device each connect one of the output connectors to the second sub-array of input connectors or the first sub-array of input connectors depending on a jumper configuration of the second array of jumper connections.

Such a switching device can be configured in a variety of ways to handle the various media source 115 and output device 110 configurations as different venues may present. For instance, the first array of first jumper connections and the second array of second jumper connections can be configured to electrically connect the second sub-array of input connectors to the output connectors and such that the first sub-array of input connectors and the second sub-array of input connectors have a termination resistance (or do not have a termination resistance) and are connected to output connectors. In another example, the first array of first jumper connections and the second array of second jumper connections can be configured to electrically connect the first sub-array of input connectors to the output connectors and such that each of the first sub-array of input connectors have a termination resistance (or do not have a termination resistance) and are connected to at least two output connectors.

Depending on the configurations of the array of the jumper connectors, a termination resistance can be matched to the input connectors in accordance with the needs of a given media system. For example, the first jumper connectors in the first array can provide electrical connections for the input connectors with a termination resistance that is preselected and about the same for more than one of the the input connectors.

Similarly, certain of the input connectors may be arranged via the jumper connections made by the jumper connectors to be available to connect to one or more output connectors. For example, the second array of second jumper connectors can be configured to route media signal received at the first array of input connectors to any of the first, second, and/or third arrays of output connectors.

This switching device is also scalable in that multiple switching devices may be interconnected such that the switching system of interconnected switching devices is able to receive more distinct media signals from media sources than a single switching device and/or output more distinct media signals than a single switching device. By variously configuring the jumper connectors, one can join together multiple scalable switch devices in one system to provide multiple arrangements suitable for various numbers of media sources and output devices. For example, in one configuration, inputs to the first scalable switch can be associated with outputs of multiple interconnected scalable switches. In one such configuration, two scalable switching devices are joined together to provide double the number of output connectors as compared to the number of input connectors. One scalable switch device will be connected so that its input connectors are connected to a termination resistance while a second scalable switch device is configured such that its input connectors do not connect to a termination resistance. By connecting the media inputs in parallel between the two sets of input connectors provided by the two switch devices, the output connectors available for the multiple media sources is doubled. Additional such configurations of the scalable switching devices can provide a variety of connections between multiple media sources and multiple output devices.

The hardware used to create the jumper connectors configuration allows the switching device to be manufactured for a much reduced cost as compared to switching devices that are otherwise commercially available. Additionally, through configuration of the jumper connectors, multiple switching devices may be banded together for use on a single system to provide scalability to a variety of potential uses. The software used to control the various switching devices described herein is readily developed by those skilled in the art. Such switching devices are further described in the co-owned application titled Scalable Switch Device and System, U.S. patent application Ser. No. 12/176,150, filed Jul. 18, 2008, the entire disclosure of which is incorporated by reference as if rewritten entirely herein.

A storage device 170 may be included in communication with the computing device 120 wherein the computing device 120 is configured to store on the storage device 170 information relating to the media output at the plurality of output devices 110. The storage device 170 may comprise any element able to store information such as a hard disk, flash memory, and the like such that the system 100 is able to store information to enhance the functionality of the system 100. For example, the information relating to the media output may include a listing of programming previously displayed on the plurality of output devices 110. The listing of programming can include a listing of when particular networks or stations of particular media sources 115 were displayed on which output devices 110. By another approach, the information may include a history of associations between media sources 115 and output devices 110. Such information may correspond to data to track how many televisions displayed certain programming. By another approach, the information may be used to determine whether certain programming or media sources 115 have been shown for a certain amount of time as may be required in certain arrangements between an establishment and media provider. For example a media provider may require that certain media sources or programming be displayed for a minimum amount of time or at certain times. The storage device 170 can store the display information to confirm the programming usage. Such information may also be available for uploading to other systems should the system 100 be configured to connect to a network 180 such as the Internet. The network connection may be a wired or wireless connection as is known in the art.

To collect such programming information, the system 100 may store the associations between media sources 115 and output devices 110 as controlled by the computing device 120. By another approach, the storage device 170 may store information relating to the configuration of the switching device 135, the media sources 115, and the output devices 110 to accurately determine what programming was actually displayed on the output devices 110 at a given time.

By another approach, the storage device 170 may also be configured to store information relating to preferred media sources 115. For example, the system 100 in such an approach may include software providing the ability for a user to designate certain media sources as preferred media sources such that these sources are given preferred listing in the guide or are automatically associated with certain output devices 110 before receiving other instructions from the user.

By still another approach, the storage device 170 may be configured to store information relating to programming to be displayed in the future. For example, a user may configure the system 100 to automatically associate certain media sources or programming with the output devices 110 at a particular future time, and these settings may be stored in the storage device 170 for the use of the computing device 120 in such a configuration.

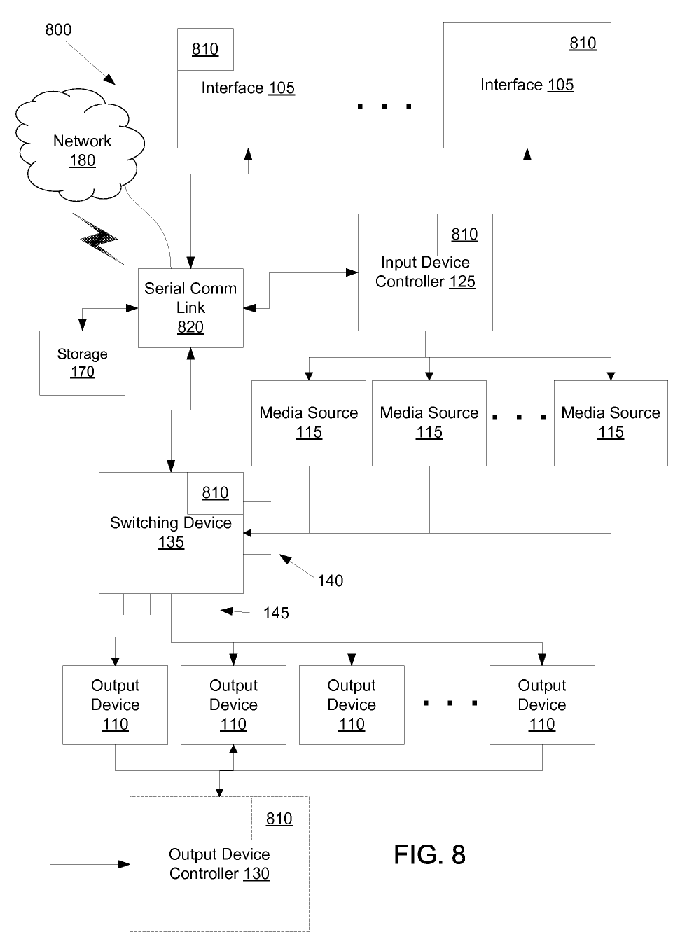

In an alternate approach described with reference to FIG. 8, the computing device 120 may include a distributed system of processors 810. In one such example system 800, the processing power and operational memory of the computing device 120 may be distributed among processors 810 located at any one or more of the other system 800 components. For example, a processor 810 may be associated with one or more of the interfaces 105, with a standalone computing device 120, a switching device 135, an input device controller 125, or an output device controller 130. The various processors 810 and the system 800 components communicate and typically work together through a serial communication link 820, which is a known electronic communication system, although other distributed electronic communication systems may be applied. The distributed system 800 allows for specialization of elements of the system 800. For example, the portions of the software necessary to generate the guide displays for the interfaces 105 may be run at the processor 810 at the interface 105. Similarly, a processor 810 at the input device controller 125 may run the portion of the software necessary to control the media content providing devices 115. The commands necessary to control the various portions of the system 800 are communicated, for example between the interface 105 and the output device controller 130, via the serial communication link 820.

Those skilled in the art will recognize and understand that such a system such as the systems 100 and 800 described herein may be comprised of a plurality of physically distinct elements as is suggested by the illustrations shown in FIGS. 1 and 8. It is also possible, however, to view these illustrations as comprising a logical view, in which case one or more of these elements can be enabled and realized via a shared platform. It will also be understood that such a shared platform may comprise a wholly or at least partially programmable platform as are known in the art.

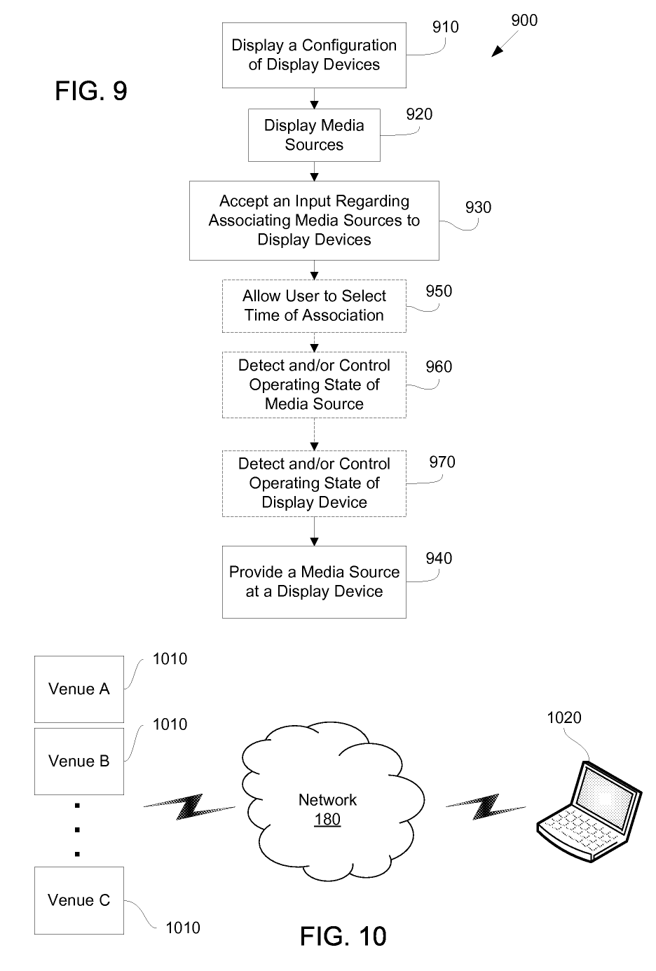

A method 900 of operation for the system 100 for controlling provision of a plurality of media sources 115 to a plurality of output devices 110 will be described with reference to FIG. 9. The method 900 includes the steps of visually displaying 910 an array of the plurality of output devices 110 on a menu illustrated on an interface 105 screen and displaying 920 a plurality of media sources 115 on the menu illustrated on the interface 105 screen. The step 910 of displaying the configuration of the plurality of output devices 110 may include displaying a floor plan comprising a representation of at least some of the output devices 110. The step 910 may also include displaying a floor plan comprising a graphical representation of at least some of the output devices 110 to visually associate the output devices 110 with a media source 115. By another approach, the method may include displaying a listing of output devices 110 or a grouping of output devices 110. Other display options for the output devices 110 are possible.

The system performing the method 900 accepts 930 a user input relating to associating at least one of the plurality of media sources 115 with at least one of the plurality of output devices 110. The input is typically provided at the interface 105, but in another approach, the system 100 may accept the input from a remote location through a wireless or wired connection, typically through a network 180. In either case, the method may include providing to the user a variety ways to provide the input to the system 100. For instance, the system 100 may provide to a user a guide of the plurality of media sources 115 and associated programming from which a user may choose for association and display on certain output devices 110. For example, a user may be able to use a touch screen on which to tap and thereby select a media source 115. The system 100 may then provide an ability for the user to select at least one of the output devices 110 when at least one of the media sources is selected to associate the at least one of the media sources with the selected at least one of the output devices 110. For example, the user may be able to select one media source 115 and then select several output devices 110 to associate that media source 115 with the selected output devices 110.

By another approach, the system 100 provides an ability to select and drag an indication of a media source 115 to an indication of at least one output device 110 to associate the media source 115 with the at least one output device 110. Similarly, the system 100 may provide an ability to select and drag an indication of at least one output device 100 to an indication of a media source 115 to associate the at least one media source 115 with the at least one output device 110. For a system with an overlay or pass-through source, for example, a user may drag a media source 115 onto a representation of the pass-through source on the visual graphic menu such that the pass-through source becomes a separate available source to associate with an output device 110. The media source 115 associated with that particular overlay can be changed in a similar manner by the user. These operations can be performed at the interface 105 using a computing device and mouse, with a touch screen, or by another suitable interface method.

At step 940, at least one of the media sources is provided at one or more of the plurality of output devices 110. The input accepted by the system 100 will typically dictate the provision of media at the output devices 110. For example, with momentary reference to FIG. 2, a user may select media devices to associate with certain media sources 115 by tapping on one or more of the representations 230 of the output devices 110 to select those devices 110 and then tapping on a media source 115 or program/network from the programming or network listing 235. The user input is communicated to a computer device 120 that associates signals effected by the user's selection of media sources 115 with signals effected to the video output devices 110 based upon the user's selection of video output devices on the interface screen. The system 100 will then display the selected network or program from the media source 115 on the selected output devices 110. By another approach, the user may select the program first before selecting the output devices 110 to display the selected program. Similar steps may be followed using the example graphical menus shown in FIGS. 3 and 4 to display the selected media source on the selected output device(s) 110 or group(s) of output devices 110. By another approach only certain output devices 110 may be capable of displaying certain content. For instance, certain output devices 110 cannot display high definition content. The system through the visual graphical menu then may show only the possible targets output devices 110 for a particular media source 115.

With reference again to FIG. 9, the method 900 may optionally include the step 950 of providing an ability for the user to select a time at which the at least one of the media sources is associated with the at least one of the output devices 10. In this step, the user can pre-program the system 100 to display certain media sources or programming at certain times. For example, a popular television show may be pre-programmed to display in a certain room or area of an establishment to allow certain clientele to regularly watch the show. Another example includes when a particular sporting event is going to be broadcast, a venue may desire to show that event on several televisions and can program the system 100 to show that event accordingly. To illustrate one such method, with momentary reference to FIG. 5, a user may a particular program by tapping on the program indication 530. Then, the user may pull up a listing or representation of output devices 110 and select one or more output devices 110 such that the selected output devices 110 will show the selected program at the time shown for the program.

The method 900 may also optionally include the step 960 of detecting and/or controlling an operating state of at least one of the plurality of media sources. This step may include providing to the user an indication of the operating state of the media sources. Similarly, the method 900 may also optionally include the step 960 of detecting and/or controlling an operating state of at least one of the plurality of output devices 110. The user may be provided an indication of the operating state of the output devices 110. These indications can provide the user with the ability to more easily manage the media content providing devices 115 and output devices 110. For instance, the user may selectively turn on or off certain media sources and/or output devices as necessary, such as at the end or beginning of the day or where certain rooms or areas are not being used such that the televisions in those areas may be turned off.

Another example option for system control includes expanding the control of a system such that systems at multiple venues may be controlled by one or more users located remotely from the venues. With reference to FIG. 10, one such example will be discussed. A plurality of venues 1010, such as a first venue A and a second venue B, may be connected to a network 180, such as the Internet or a private computer network. Each venue 1010 includes at least one interface 105 and at least one computing device 120. The system 1000 includes a remote interface 1020 in communication with the computing devices 120 at the first venue A 1010 and at the second venue B 1010 such that media output at the first venue A and the second venue B is controllable from the remote interface 1020. The remote interface 1020 may comprise a computer disposed at a central office related to the venues 1010, a laptop computer connectable to the network 180, or other device able to communicate through the network 180. Firewalls and/or password protection may be employed to restrict access by the remote interface 1020 to only those venues accessible by its user. By one approach, the remote interface 1020 is configured to provide an indication of media output at the first location A and the second location B. So configured, a person at the remote interface 1020 may control the media provided at any of the venue 1010 connected to the network 180. For instance, the remote interface 1020 may provide a representation of the venue such that the user may select a venue, whereupon a representation or floor plan of the selected venue is provided to the user. The representation may be any of those discussed above with respect to local output devices 110.

So configured, the system may provide a variety of user guides for associating media content or programming with certain output devices, such as televisions. A user may then use the guides at one or more conveniently placed interfaces to control all of the televisions in the establishment, thereby reducing or eliminating the need to use separate controls to control the televisions or media sources. The system also can track display data, for example, to maintain data for the establishment or to confirm that certain media is being displayed for a given amount of time.

Those skilled in the art will recognize that a wide variety of modifications, alterations, and combinations can be made with respect to the above described embodiments without departing from the spirit and scope of the invention. For example, systems may be designed having various combinations of the disclosed components and other known components. For instance, one example combination includes at least one interface 105 screen configured to visually illustrate to a user a plurality of media sources 115 and a plurality of video output devices 110 and a computer 120 configured to communicate with the interface 105 screen to effect signals to the plurality of video output devices 110 based upon the user's selection of video output devices 110 on the interface 105 screen. An input device controller 125 communicates with the computer device 120 and the plurality of media sources 115 to control provision of media content provided by the media sources 115 to video output devices 110 and control at least one operating state for the media sources 115. As described above, an output device controller 130 may be included and communicate with the computing device 120 wherein the output device controller 130 is configurable to control at least one state of the output device 110. The output device controller 130 and the input device controller 125 may therefore provide the user the ability to control the state of the devices such as the on/off state, input configuration, display settings, and the like.

Such systems as described herein may also include a guided testing process to confirm the proper operation and connection of the media sources, output devices, and software. The systems may also include reboot/reset features and stored preferred configuration or source to output device associations at start up. Such modifications, alterations, and combinations are to be viewed as being within the ambit of the inventive concept.

We claim:

1. A system that controls the distribution of media output signals from at least one media source to a plurality of output devices, the system comprising:
at least one interface configured to provide to a user a visual graphical menu of a plurality of options to associate signals from at least one media source with the plurality of media output devices and effect signals to the media output devices comprising at least a plurality of video output devices; and
a computing device configured to communicate with the at least one interface and at least one of the group consisting of at least one media source and at least one of the media output devices to send commands to at least one of the at least one media source and the at least one of the media output devices to effect a configuration of at least one of the at least one media source and the at least one of the media output devices, the computing device configured to receive signals from the interface and associate signals from the at least one media source with the plurality of output devices,
the visual graphical menu providing to the user a visual graphical display of the at least one media source and the plurality of output devices available for association, the visual graphical menu permitting the user to select and associate the at least one media source with one or more of the plurality of media devices and distribute signals selected from the group consisting of video signals and audio signals to user selected output devices.

2. The system of claim 1 wherein the graphical menu comprises at least one of a group comprising:
a floor plan comprising a representation of at least one of the output devices;
a listing of available media sources and a floor plan comprising a representation of at least one of the output devices, the computing device associating user selected output devices on the floor plan with media sources visually illustrated on the graphical menu;
a floor plan comprising a graphic representation of at least one of the output devices that is at least similar to a graphic representation of a media source to visually associate the at least one of the output devices with a media source;
a listing of output devices;
a listing of groups of output devices;
a program listing;
a network listing;
a station listing;
a listing of available media sources at a plurality of times;
a listing of available programming at a plurality of times;
a plurality of images relating to available programming on a guide;
a plurality of images relating to available programming on a guide at plurality of times;
a plurality of thumbnails comprising images representing media sources.

3. The system of claim 1 wherein the at least one interface comprises at least one of a group comprising at least one touch screen, and a computing device interface operated in combination with a pointing device.

4. The system of claim 1 wherein the interface is a video monitor.

5. The system of claim 4 wherein the video monitor is a touch screen monitor.

6. The system of claim 1 wherein the computing device comprises a distributed system of processors.

7. The system of claim 6 wherein the distributed system of processors includes at least one of a group comprising a processor associated with the at least one interface, a processor associated with a standalone computing device, and a processor associated with the switching device.

8. The system of claim 1 wherein the computing device is configured to disable at least one of the media sources such that the disabled media sources are not available to the user to be associated with an output device.

9. The system of claim 1 wherein the computing device is configured to associate predetermined programming with predetermined output devices for at least one predetermined time period.

10. The system of claim 1 wherein the computing device is configured to lock at least one of the media sources to at least one output device such that a locked indication is provided to a user via the at least one interface when the user attempts to change a locked output device.

11. The system of claim 10 wherein the computing device is configured to allow a user to override the locked indication to change an association between the at least one of the media sources to the at least one output device.

12. The system of claim 1 wherein the computing device is configured to lock at least one of the media sources to particular programming such that a locked indication is provided to a user via the at least one interface when the user attempts to change a locked media source.

13. The system of claim 12 wherein the computing device is configured to allow a user to override the locked indication to change programming provided by the at least one of the media sources.

14. The system of claim 1 further comprising an input device controller in communication with the computing device, the input device controller configurable to be in communication with at least one media content providing device to control provision of content provided by the at least one media content providing device.

15. The system of claim 14 wherein the input device controller comprises at least one of a serial controller, an infra-red controller, a network connection between the system and the media content providing device, and a wireless network connection between the system and the media content providing device.

16. The system of claim 1 further comprising an input device controller in communication with the computing device, the input device controller configurable to be in communication with at least one media content providing device to detect and control at least one operating state of the at least one media content providing device.

17. The system of claim 1 further comprising an output device controller in communication with the computing device, the output device controller configurable to be in communication with at least one of the plurality of output devices to detect and control at least one operating state of the at least one of the plurality of output devices.

18. The system of claim 1 further comprising a switching device comprising a plurality of inputs configured to receive media signals from media sources and a plurality of outputs configured to provide media signals, the switching device controlled by the computing device to associate certain of the plurality of inputs with certain of the plurality of outputs.

19. The system of claim 1 further comprising a storage device in communication with the computing device wherein the computing device is configured to store on the storage device information relating to the media output at the plurality of output devices.

20. The system of claim 19 wherein the information relating to the media output at the plurality of output devices comprises a listing of programming previously displayed on the plurality of output devices.

21. The system of claim 20 wherein the listing of programming previously displayed on the plurality of output devices includes a listing of when particular channels of particular media sources were displayed on which output devices.

22. The system of claim 20 wherein the listing of programming previously displayed on the plurality of output devices includes a history of associations between media sources and output devices.

23. The system of claim 1 further comprising a storage device in communication with the computing device wherein the computing device is configured to store on the storage device information relating to preferred media sources.

24. The system of claim 1 wherein the system is configurable to automatically associate certain media sources with certain output devices at a particular future time.

25. The system of claim 1 further comprising at least one interface and at least one computing device at a first venue and at least one interface and at least one computing device at at least a second venue; the system further comprising a remote interface in communication with the computing devices at the first venue and the second venue such that media output at the first venue and the second venue is controllable from the remote interface.

26. The system of claim 25 wherein the remote interface is configurable to provide an indication of media output at the first venue and the second venue.

27. The system of claim 1 wherein the media source comprises a primary media source and a secondary media source.

28. The method of claim 27 wherein the secondary media source comprises a plurality of programming options available from a single primary media source.

29. The method of claim 27 wherein the secondary media source comprises a source configured to add content to media from a primary media source.

30. A method of distributing signals from at least one media source to a plurality of video output devices, the method comprising:
visually displaying an array of the plurality of output devices on a menu illustrated on an interface screen;
visually displaying the at least one of the media source on the menu illustrated on the interface screen;
accepting a user input relating to the at least one of the of media source and the plurality of output devices; and
communicating the user input to a computer device that associates the user input related to the media source and the at least one of the plurality of output devices to effect a signal from the media source to the output device;
communicating a command signal from the computer device to at least one of the group consisting of the at least one media source and at least one of the plurality of video output devices to effect a configuration of at least one of the at least one media source and the at least one of the plurality of video output devices to effect the signal from the media source to the output device.

31. The method of claim 30 wherein visually displaying the array of the plurality of output devices on the menu illustrated on the interface screen comprises displaying at least one of a group comprising:
a floor plan comprising a representation of at least some of the output devices;
a floor plan comprising a graphic representation of at least one of the output devices that is at least similar to a graphic representation of a media source to visually associate the at least one of the output devices with a media source;
a listing of output devices;
a listing of groups of output devices.

32. The method of claim 30 wherein visually displaying the at least one of the media source on the menu illustrated on the interface screen comprises displaying at least one of a group comprising:
a program listing;
a network listing;
a station listing;
a listing of available media sources at a plurality of times;
a listing of available programming at a plurality of times;
a plurality of images relating to available programming on a guide;
a plurality of images relating to available programming on a guide at plurality of times;
a plurality of thumbnails comprising images representing media sources.

33. The method of claim 30 wherein accepting a user input relating to the at least one of the of media source and the plurality of output devices comprises at least one of a group comprising:
providing an ability for the user to select at least one of the media sources;
providing an ability for the user to select at least one of the output devices when at least one of the media sources is selected to associate the at least one of the media sources with the selected at least one of the output devices;
providing an ability to select and drag an indication of at least one media source to an indication of at least one output device to associate the at least one media source with the at least one output device;
providing an ability to select and drag an indication of at least one output device to an indication of at least one media source to associate the at least one media source with the at least one output device.

34. The method of claim 33 further comprising providing an ability for the user to select a time at which the at least one of the media sources is associated with the at least one of the media output devices.

35. The method of claim 30 further comprising detecting an operating state of at least one of the plurality of media sources.

36. The method of claim 35 further comprising providing to a user an indication of the operating state of at least one of the plurality of media sources.

37. The method of claim 30 further comprising detecting an operating state of at least one of the plurality of output devices.

38. The method of claim 37 further comprising providing to a user an indication of the operating state of at least one of the plurality of output devices.

39. The method of claim 30 further comprising controlling an operating state of at least one of the plurality of media sources.

40. The method of claim 30 further comprising controlling an operating state of at least one of the plurality of media display devices.

41. A system for controlling media output from a plurality of media sources to at a plurality of video output devices comprising:
at least one interface screen configured to visually illustrate to a user a plurality of media sources and a plurality of video output devices; and
a computer configured to communicate with the interface screen, to effect signals to the plurality of the video output devices, and to communicate with at least one of the group consisting of at least one of the plurality of media sources and at least one of the plurality of video output devices to send commands to and to effect a configuration of at least one of the plurality of media sources and at least one of the plurality of video output devices to associate signals effected by the user's selection of media sources with signals effected to the video output devices based upon the user's selection of video output devices on the interface screen.

42. The system of claim 41 further comprising an input device controller that communicates with the computer device and the plurality of media sources to control provision of media content provided by the media sources to video output devices and to determine and control at least one operating state for the at least one of the plurality of media sources.

43. The system of claim 41 further comprising an output device controller that communicates with the computer device and the plurality of output devices to determine and control at least one operating state for the plurality of output devices.

44. The system of claim 41 further comprising at least one interface and at least one computing device at a first venue and at least one interface and at least one computing device at at least a second venue; the system further comprising a remote interface in communication with the computing devices at the first venue and the second venue such that media output at the first venue and the second venue is controllable from the remote interface.

45. The system of claim 44 wherein the remote interface is configured to provide an indication of media output at the first venue and the second venue.
